(19) United States
(12) Patent Application Publication
(10) Pub. No.: US 2004/0256303 A1
(43) Pub. Date: Dec. 23, 2004

(54) Fluid filter element in fixed shower arm

(76) Inventors: Todd Talbot, Northville, MI (US); Charles P. Mistovich, Bluffton, OH (US); David L. Pinkston, Romulus, MI (US)

Correspondence Address: Edgar A. Zarins, Masco Corporation, 21001 Van Born Road, Taylor, MI, 48180, US

(21) Appl. No.: 10/745,408

(22) Filed: Dec. 22, 2003

Related U.S. Application Data
(60) Provisional application No. 60/479,679, filed on Jun. 19, 2003.

(51) Int. Cl. B01D 35/02

(52) U.S. Cl. 210/232

(57) ABSTRACT

A fixed shower arm housing a filter media to remove contaminants, particulates and additives from the water flowing through the filtered shower arm and through an attached showerhead. The shower arm includes a housing attached to the outlet pipe and having a neck portion adapted to accommodate a hand-held or fixed showerhead. An adjustable escutcheon facilitates mounting of the housing to the outlet pipe while also creating an even flow into the housing and through the filter media. Water flows from the inlet pipe through the filter element to the shower neck.

### RELATED APPLICATIONS

This application claims priority from U.S. Provisional Application No. 60/479,679 filed on Jun. 19, 2003.

### BACKGROUND OF THE INVENTION

I. Field of the Invention

This invention relates to an apparatus for removing undesirable elements from a fluid stream and, in particular, to a filtering device which forms the shower arm of a wall-mounted shower assembly to filter particulates and other elements from the fluid prior to flowing through the showerhead.

II. Description Of The Prior Art

Consumers have become increasingly concerned with the quality of the water flowing to their homes. While the primary concerns are the particulates, contaminants and additives found in drinking water, these concerns have extended to bathing. The variety of filtering devices employed to improve drinking water are well known and include simple devices which attach to the spout to whole house systems for filtering drinking water as it enters the home. Such devices include a filter media to trap and remove a growing list of elements from the water to improve its taste, odor and health. After a predetermined time, the filter element needs to be cleaned or replaced to maintain its effectiveness.

Of more recent concern are the effects of the water supply during bathing. Filter devices have been employed in connection with the showerhead to remove particulates and contaminants before the water flows over the user. It has also been found that the removal of chlorine from the fluid flow improves hair and skin care. However, the prior known shower filtering devices have been expensive, bulky and aesthetically unappealing. The early filter devices employed a secondary housing for the media through which the water is diverted. In order to accommodate the flow demands, these add-on devices were large structures attached to the showerhead. Attempts have been made to house the filter media within the showerhead itself. This increased the size and weight of the showerhead. Replacement was both inconvenient and expensive. Furthermore, such showerhead filters did not filter the water diverted to a hand-held shower.

### SUMMARY OF THE PRESENT INVENTION

The present invention overcomes the disadvantages of the prior art by providing a filter media housed within the wall-mounted shower arm such that water flowing to the fixed showerhead or a hand-held showerhead is filtered of particulates, contaminants and additives.

The shower system according to the present invention is mounted to a wall of the shower enclosure. A fixed outlet extends through the wall and includes external threads. A filter housing with a removable filter media is threadably mounted to the outlet pipe such that fluid flow from the plumbing system is directed into the housing. A neck portion extends from the distal end of the housing and is removably mounted to the housing by a lock cap. The shower neck includes means for mounting a shower device, hand-held or fixed, to the shower arm. As a result, water flows from the outlet, into the housing and through the media to the showerhead. After a predetermined period of use, the filter media within the shower arm will need to be replaced. Upon removal of the lock cap, the filter media can be accessed and replaced within the housing with little effort and expense. The filter media may be provided in a number of forms depending on the desired results including simple filter materials and more complex and contained filter cartridges.

The housing flange member facilitates adjustment of the device relative to the wall thereby ensuring snug, flush engagement against the wall. This adjustment accommodates outlet pipes of different lengths since each plumbing installation will be different. Further, by placing the filter housing in the shower arm, filtered water will be directed to any type of showering device attached to the arm. This can include a fixed showerhead alone, a hand-held shower attached to the shower arm by a hose, or a diverter to accommodate both the fixed and hand-held shower.

Other objects, features and advantages of the invention will be apparent from the following detailed description taken in connection with the accompanying drawings.

### BRIEF DESCRIPTION OF THE DRAWINGS

The present invention will be more fully understood by reference to the following detailed description of a preferred embodiment of the present invention when read in conjunction with the accompanying drawing, in which like reference characters refer to like parts throughout the views and in which:

FIG. 1 is a perspective view of a fixed shower arm with a fluid filter element embodying the present invention;

FIG. 2 is an exploded view thereof;

FIG. 3 is a cross-sectional view of a first embodiment thereof;

FIG. 4 is a cross-sectional view of a second embodiment thereof; and

FIG. 5 is a perspective view of an alterative embodiment of the present invention.

### DETAILED DESCRIPTION OF A PREFERRED EMBODIMENT OF THE PRESENT INVENTION

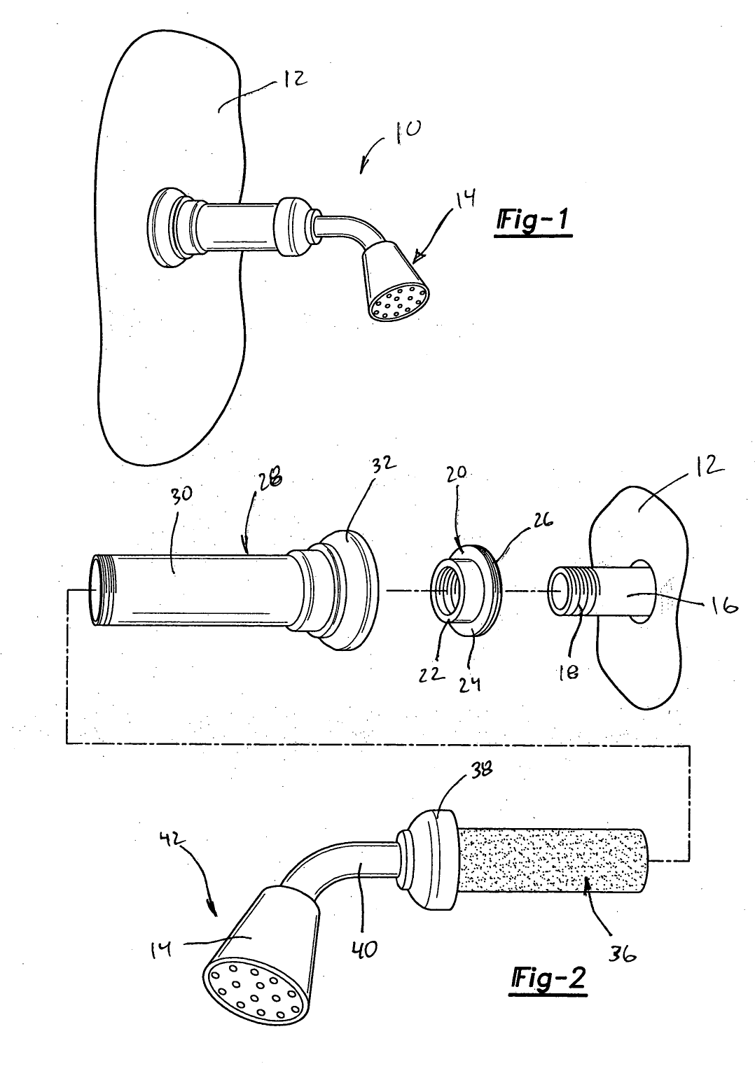

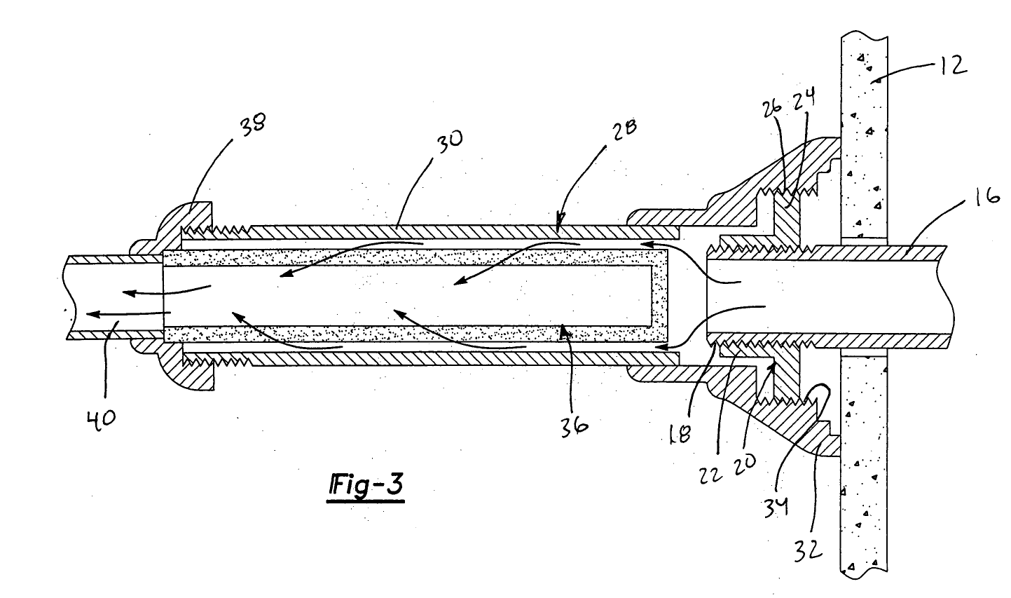

Referring first to FIG. 1, there is shown a fixed shower assembly 10 mounted to a wall 12 of a shower enclosure. As is typical, plumbing for the shower assembly 10 is disposed behind the wall 12 and is connected to a valve (not shown) for controlling the temperature and flow of the water to the shower assembly 10. The shower assembly 10 will be fixed in a raised position along the wall 12 to deliver bathing water from substantially above the user. Mounted to the shower assembly 10 of the present invention is a fixed showerhead 14. However, it shall be understood that the present invention may be employed with a hand-held shower and a variety of showerheads 14.

Referring now to FIGS. 1 and 2, the internal plumbing includes an outlet pipe 16 extending from the wall 12. Preferably, the outlet pipe 16 includes external threads 18 and a predetermined length. In this first embodiment, an adapter flange 20 is threadably mounted to the outlet pipe 16. The adapter flange 20 includes a tubular portion 22 internally threaded to mate with the outlet pipe 16 and an outwardly extending radial flange 24. The radial flange 24 includes threads 26 formed on the outer edge. The threaded component 26 allows for flush adjustment to the wall.

A housing 28 is adapted to be mounted to the flange 20 and over the outlet pipe 16 such that fluid flow from the outlet is directed into the housing 28. The housing 28 includes a tubular portion 30 and an escutcheon 32. The escutcheon 32 includes an internally threaded portion 34 for threadably engaging the external threads 26 of the flange 20. The tubular portion 30 of the housing 28 is sized to receive filter means 36 which may include anything from a simple filter material or membrane to a filter cartridge with various types or layers of filter materials. The filter means 36 will be positioned within the housing 28 such that water flows therethrough. The filter means 36 is enclosed within the housing 28 by an end cap 38 having an outlet 40. The end cap 38 is internally threaded so as to matingly receive the housing 28. The outlet 40 of the end cap 38 will be positioned such that water passing through the filter means 36 is directed through the outlet 40.

Attached to the outlet 40 is a bathing device 42. The bathing device 42 may include the showerhead 14 shown in the drawing. Other embodiments of the shower assembly 10 may include a diverter valve with a hand-held shower in conjunction with the showerhead 42 or may include a shower hose with a hand-held shower.

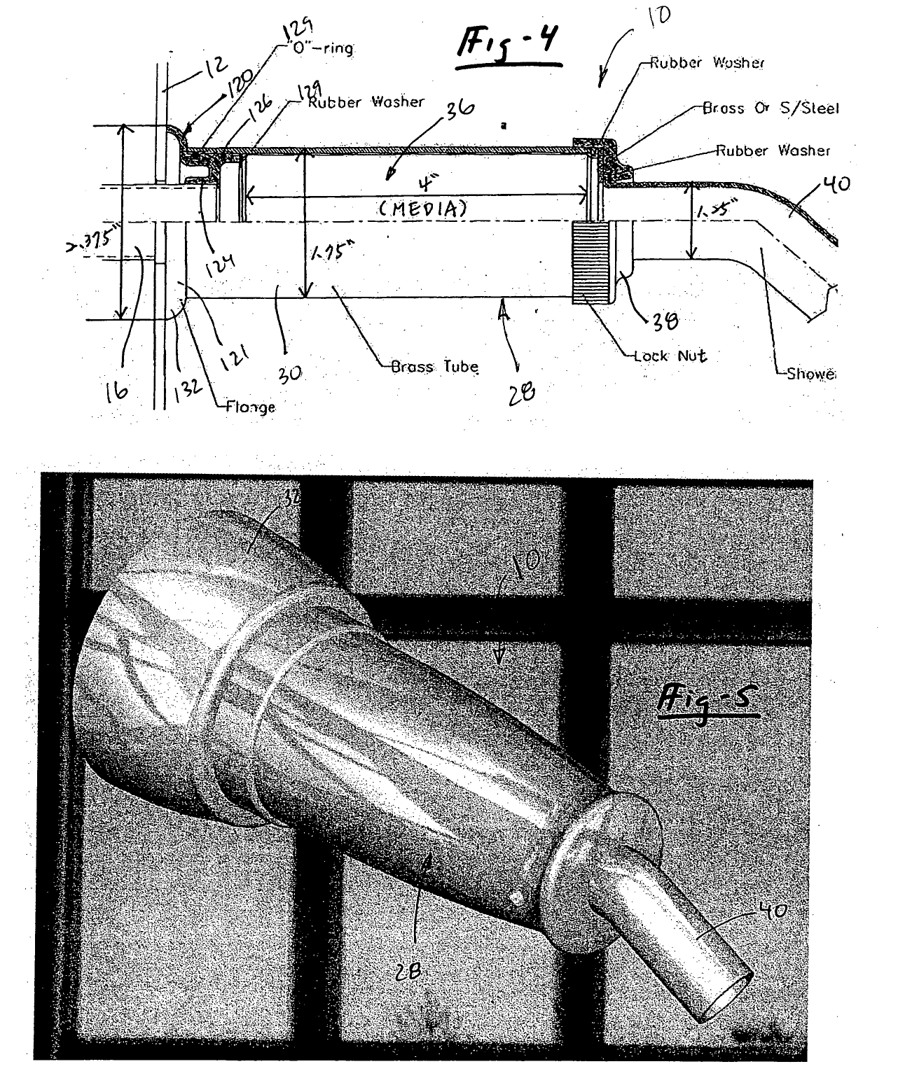

FIG. 4 discloses a variation of the shower assembly 10. The flange 120 which matingly receives the outlet pipe 16 includes an enlarged escutcheon portion 121 which extends beyond the diameter of the tubular housing 30. The tubular portion 122 of the flange 120 includes coaxial walls 124 and 126. The inner tubular wall 124 includes inner threads 128 to engage the outlet pipe 16. The outer tubular wall 126 matingly engages the housing 30 and includes seal members 129 to prevent fluid flow therebetween.

FIG. 5 discloses a fixed shower assembly 10 with a more contoured or aesthetically appealing structure.

The various embodiments of the present invention facilitate the removal of elements, contaminants, particulates and additives from the fluid stream emitting from the bathing device 42 depending upon the structure of the filter means 36 employed. Unlike prior known shower filters which are structured around the showerhead, the present invention provides a much more appealing structure by positioning the filter means 36 in the fixed shower arm. Water flowing from the outlet pipe 16 will be directed into and through the filter means 36 to the outlet 40. After a predetermined time period or uses, the filter means 36 will need to be replaced. The end cap 38 is removed allowing removal of the filter means from the housing 30. Once replaced, the end cap 38 is attached to the housing 30 and the filtering shower system 10 is again ready to use. Since any of the known bathing devices 42 can be attached to the shower arm 10, the filtered water will flow from the fixed showerhead or the hand-held shower as desired.

The housing flange member facilitates adjustment of the device relative to the wall thereby ensuring snug, flush engagement against the wall. This adjustment accommodates outlet pipes of different lengths since each plumbing installation will be different. Further, by placing the filter housing in the shower arm, filtered water will e directed to any type of showering device attached to the arm. This can include a fixed showerhead alone, a hand-held shower attached to the shower arm by a base or a diverter to accommodate both the fixed and hand-held shower.

The foregoing detailed description has been given for clearness of understanding only and no unnecessary limitations should be understood therefrom as some modifications will be obvious to those skilled in the art without departing from the scope and spirit of the appended claims.

What is claimed is:

1. A wall-mounted shower assembly adapted to fluidly communicate with a fluid outlet extending from the wall, said shower assembly comprising:
a housing detachably secured to the fluid outlet, said housing having an outlet passageway;
filter means disposed within said housing such that fluid flowing from the fluid outlet passes through said filter means to said outlet passageway; and
a bathing device fluidly connected to said outlet passageway of said housing.

2. The shower assembly as defined in claim 1 and further comprising an adapter flange mounted to the fluid outlet, said housing connected to said adapter flange.

3. The shower assembly as defined in claim 2 wherein said housing includes an end cap having said outlet passageway formed therein, said end cap selectively detachable from said housing for access and selective removal of said filter means from said housing.

4. The shower assembly as defined in claim 1 wherein said bathing device is a showerhead, said housing forming a fixed arm for said showerhead.

5. The shower assembly as defined in claim 4 wherein said bathing device is a hand-held shower fluidly connected to said housing by a flexible hose.

6. The shower assembly as defined in claim 2 wherein said housing is adjustably mounted to said adapter flange to ensure engagement of said housing with the wall to conceal the fluid outlet.

7. The shower assembly as defined in claim 6 wherein said housing is threadably connected to a peripheral edge of said adapter flange.

8. The shower assembly as defined in claim 7 wherein said adapter flange is threadably connected to the fluid outlet.

9. A wall-mounted assembly adapted to fluidly communicate with a fluid outlet extending from the wall, said shower assembly comprising:
an adapter flange secured to the fluid outlet;
a housing adjustably mounted to said adapter flange such that the fluid outlet is in communication with an interior of said housing, said housing having an outlet passageway;
filter means disposed within said housing wherein fluid flowing from the fluid outlet passes through said filter means to said outlet passageway; and
a bathing device fluidly connected to said outlet passageway of said housing.

10. The shower assembly as defined in claim 9 wherein said housing includes an end cap having said outlet passageway formed therein, said end cap selectively detachable from said housing for access and selective removal of said filter means from said housing.

11. The shower assembly as defined in claim 9 wherein said bathing device is a showerhead, said housing forming a fixed arm for said showerhead.

12. The shower assembly as defined in claim 9 wherein said bathing device is a hand-held shower fluidly connected to said housing by a flexible hose.

13. The shower assembly as defined in claim 10 wherein said housing is threadably connected to a peripheral edge of said adapter flange.

14. The shower assembly as defined in claim 13 wherein said adapter flange is threadably connected to the fluid outlet.
